(19) United States
(12) Patent Application Publication
(10) Pub. No.: US 2003/0161356 A1
(43) Pub. Date: Aug. 28, 2003

(54) Tunable filter

(76) Inventors: Kenneth Guild, London (GB); Michael O'Mahony, Suffolk (GB); Anna Tzanakaki, Essex (GB); Dimitra Simeonidou, Essex (GB)

Correspondence Address: BUCKLEY, MASCHOFF, TALWALKAR, & ALLISON, 5 ELM STREET, NEW CANAAN, CT, 06840, US

(21) Appl. No.: 10/240,288

(22) PCT Filed: Mar. 28, 2001
(86) PCT No.: PCT/GB01/01372

(30) Foreign Application Priority Data
Mar. 28, 2000 (GB) 0007549.9

(51) Int. Cl. H04J 3/02

(52) U.S. Cl. 370/542

(57) ABSTRACT

An optical tunable filter/wavelength converter comprises an input for multiple wavelength traffic carrying signals λ₁-λₘ, an output for converted wavelength carrying signals (λ₁′-λₘ′), means (20) for routing each of the traffic carrying signals through a demultiplexer to an individual semiconductor optical amplifier (SOA) (22) or to an interferometer arrangement. A laser source (26) provides a further input wavelength to the SOAs, or to the interferometer arrangements, to enable cross-gain or cross-phase modulation from the input signal which thereby provides the converted signal. Means is provided for selectively routing the converted signal to the output.

### FIELD OF THE INVENTION

This invention relates to optical signal transmission and more particularly to a tunable filter incorporating a wavelength converter useable in optical cross-connects and optical add-drop multiplexers.

### BACKGROUND TO THE INVENTION

In optical signal transmission networks traffic is carried on multiple wavelengths employing wavelength division multiplexing (WDM) in order to increase the utilisation of the fibre bandwidth. The separation and detection of specific wavelengths carrying traffic is carried out at the receiving stations. Network traffic allocation and routing are performed and managed in optical add-drop multiplexers/optical cross-connects, and optical packet switch nodes. The traffic for each particular desired destination is allocated a particular wavelength and may be in the form of a continuous stream of data or in the form of packets, of variable or fixed length, having different wavelengths. The nodes should provide routing or reconfiguration of the network such that the incoming signal is routed on per wavelength (circuit switches) or per packet (packet switches) basis in order to allow for traffic allocation, network growth and survivability of the data. This invention seeks to provide a combined wavelength converter and tunable filter configuration suitable for enabling appropriate traffic routing in optical add-drop multiplexers, optical cross-connects and optical packet switches.

### SUMMARY OF THE INVENTION

According to a first aspect of the present invention, there is provided a tunable filter comprising an optical input for a wavelength division multiplexed (WDM) signal, a demultiplexer connected to the optical input, a number of wavelength converters, the demultiplexer routing each of a number of individual wavelength channels on the WDM signal to a respective wavelength converter, and an optical coupler coupled to each of the wavelength converters and to an optical output, wherein each wavelength converter is adapted to convert the wavelength of an input signal and/or effect selective switching of an input signal to the optical coupler.

Preferably, the wavelength converter comprises one or more semiconductor optical amplifiers (SOAs). The wavelength converter may be arranged as a single SOA or as an interferometer arrangement utilising a number of SOAs. One or more SOAs are gated to provide selective switching so as to provide a filtering function.

According to a second aspect of the present invention, there is provided an optical tunable filter/wavelength converter comprising an input for multiple wavelength traffic carrying signals, an output for converted wavelength carrying signals, means for routing each of the traffic carrying signals from the input to a demultiplexer, and means for routing each demultiplexed wavelength to an individual semiconductor optical amplifier (SOA) or to an interferometer arrangement utilising SOAs, a laser source providing a further input wavelength to each of the SOAs or interferometer arrangements to enable cross-gain or cross-phase modulation of the input signal, thereby to provide the converted signal and means for routing the converted signals to the output.

The means for selectively routing the converted signals to the output may comprise injection current control means to prevent or enable operation of individual SOAs thereby to effect selective switching of converted signal to the output.

The tunable filter/converter may be provided with a more elaborate SOA configuration, the arrangement being such as to provide 2R regeneration conversion by cross-phase modulation.

The wavelength(s) of the laser source may be variable to change the wavelength of the output signals. This variability may be effected by means of one or more variable wavelength lasers or by a plurality of lasers of different wavelengths, which lasers are individually selectable to provide the further input wavelength.

The invention may include a demultiplexer having an input for an optical fibre line, several outputs each for a different wavelength signal each of which outputs is coupled via an optical coupler having an output for connection to an optical fibre line.

### BRIEF DESCRIPTION OF THE DRAWINGS

Examples of the present invention will now be described in detail with reference to the accompanying drawings, in which:

FIG. 1 illustrates a combined tunable filter/wavelength converter constructed in accordance with the invention and incorporating a demultiplexer;

FIG. 2 illustrates an individual wavelength converter for incorporation in the tunable filter/wavelength converter of FIG. 1;

FIG. 3 illustrates an alternative individual wavelength converter for incorporation in the tunable filter/wavelength converter of FIG. 1; and,

FIG. 4 illustrates an alternative laser source useable in the individual wavelength converters of FIGS. 2 and 3.

### DETAILED DESCRIPTION

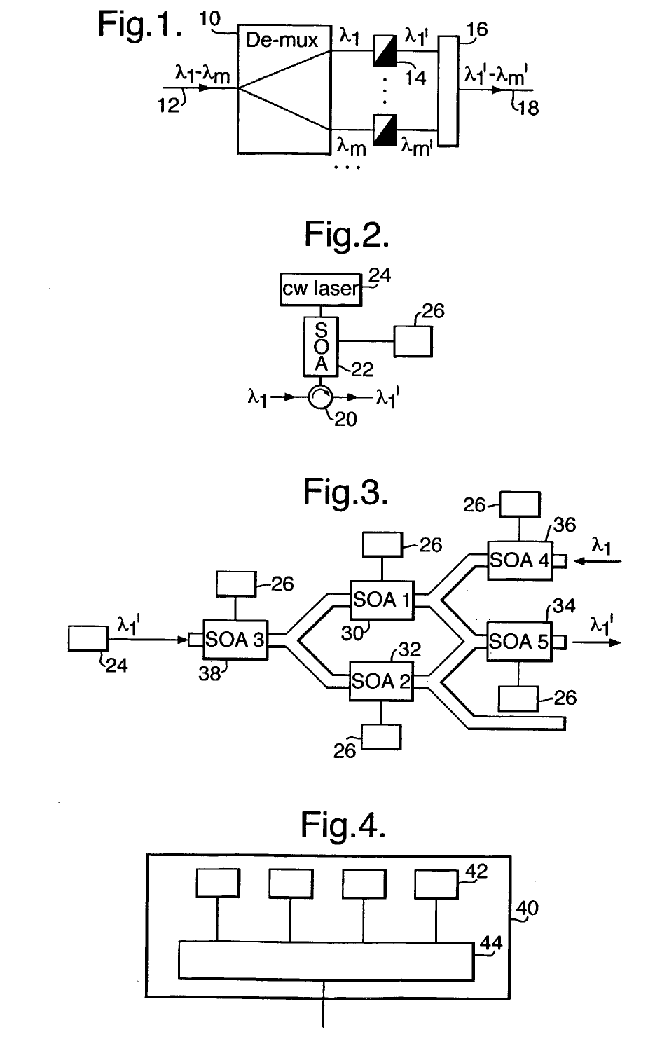

FIG. 1 shows an optical wavelength converter which has a de-multiplexer 10 having an input connected to an input optical fibre 12 from which it receives a WDM signal comprising wavelengths λ₁-λₘ. The signal is demultiplexed and each wavelength is provided on an individual output of the demultiplexer. Each output is coupled via an individual wavelength converter 14, to a coupler or combiner 16 the output of which provides wavelengths λ₁-λₘ′ to an output optical fibre 1B.

One converter 14 is illustrated in more detail in FIG. 2 where it can be seen that an input wavelength λ₁ from the demultiplexer 10 is fed to an input of a circulator 20 and is routed out via its next terminal to a semiconductor optical amplifier (SOA) 22. A continuous wave laser source 24 having a wavelength λ₁′ is also provided as another input to the SOA which amplifier is switched on or off by an injection current control means 26 and when switched on the wavelength λ₁′ is cross-gain modulated by the traffic signal on λ₁ and is routed back into the circulator and emerges from the third terminal where it is coupled to the combiner 16. It will be appreciated that any one or more of the demultiplexed signals can be routed to the combiner 16. Instead of employing a circulator, any other suitable coupling arrangement may be employed e.g. an optical coupler/isolator.

An alternative individual wavelength converter 14 is illustrated in FIG. 3 and comprises first and second SOAs 30 and 32 connected in parallel so as to form a Mach-Zender interferometer. One side of these SOAs receives the data carrying signal λ₁ from the demultiplexer 10 and the other side receives the carrier wavelength λ₁′ from the laser source 24. The SOAs are each provided with an injection current by a control means 26 and when switched on the λ₁′ signal is cross phase modulated in the two SOAs. By optimising the operation of the interferometer 2R regeneration conversion may be provided. It may be advantageous to ensue synchronised switching of the SOAs. The combined output of the SOAs 30 and 32 is routed via a third SOA 34 which again has injection current control by a control means 26 and acts as a wavelength gate for selectively routing the converted signal to the coupler 16. The input data signal λ₁ and carrier wave signal λ₁′ from the laser source 24 are also coupled to SOAs 30 and 32 via individual SOAs 36 and 38 again having injection current provided by control means 26. Alternative interferometer configurations may be employed, for example a Michelson interferometer arrangement.

The laser source 24 employed in FIGS. 2 and 3 may be a variable wavelength laser or alternatively a laser source 40 may comprise a plurality of lasers 42 such as is shown in FIG. 4. These lasers are coupled via a combiner 44 to provide the continuous wave input of the combiner. The lasers may be individually switched on/off to select the desired wavelength or may be on continuously and be coupled selectively by optical switches in the combiner 44.

The arrangements described enable the provisions of a circuit-switched and packet switched network employing optical wavelength routing. The wavelength routing may be facilitated by the combination of the demultiplexer and wavelength converter acting as a tuneable filter that enables dynamic reconfiguration of the network. The proposed configuration permits implementations of both tuneable filtering, where any one or more wavelengths is selected for routing and tunable or fixed all-optical wavelength conversion. The tuning speed of the filter is determined by the switching time of the SOA gates (˜2 ns) and therefore very fast tuning is feasible. In the case of tuneable wavelength conversion the tuning speed of the wavelength converter is determined by the tuning speed of the tunable laser source.

An additional feature of this design is the reduction of the penalty due to crosstalk at the output combiner. The conventional configuration for fast tunable filters comprises a demultiplexer, SOA gates and a combiner at the output which may introduce significant interferometric crosstalk originating from the input demultiplexer. The crosstalk penalty may be considerably high depending on the number of wavelengths supported and the crosstalk performance of the demultiplexer. However, this penalty can be eliminated with the use of the wavelength conversion stage at the output of the demultiplexer.

1. A tunable filter comprising an optical input for a wavelength division multiplexed (WDM) signal, a demultiplexer connected to the optical input, a number of wavelength converters, the demultiplexer routing each of a number of individual wavelength channels on the WDM signal to a respective wavelength converter, and an optical coupler coupled to each of the wavelength converters and to an optical output, wherein each wavelength converter is adapted to convert the wavelength of an input signal and/or effect selective switching of an input signal to the optical coupler.

2. A tunable filter according to claim 1, wherein the wavelength converter comprises one or more semiconductor optical amplifiers.

3. An optical tunable filter/wavelength converter, comprising an input for multiple wavelength traffic carrying signals, an output for converted wavelength carrying signals, means for routing each of the traffic carrying signals from the input to a demultiplexer, means for routing each demultiplexed wavelength to an individual semiconductor optical amplifier (SOA) or to an interferometer arrangement, a laser source providing a further input wavelength to each of the SOAs or interferometer arrangements to enable cross-gain or cross-phase modulation of the input signal, thereby to provide the converted signal and means for selectively routing the converted signals to the output.

4. A tunable filter/wavelength converter according to claim 3, wherein the means for selectively routing the converted signals to the output comprises injection current control means to prevent or enable operation of the SOAs thereby to effect selective switching of converted signals to the output.

5. A tunable filter/wavelength converter according to claim 3 or 4, wherein the converted signal(s) is/are coupled to the output via another SOA.

6. A tunable filter/wavelength converter according to claim 3, 4 or 5, wherein the input signal(s) is/are routed via a further SOA.

7. A tunable filter/wavelength converter according to claim 6, wherein the laser source is coupled to the SOA configuration by SOAs via yet another SOA.

8. A tunable filter/wavelength converter according to any one of claims 5 to 7, wherein each SOA is provided with injection current control means to prevent or enable operation of the SOA to control routing of the traffic carrying signals.

9. A tunable filter/wavelength converter according to any of claims 3 to 8, wherein the wavelength of the laser source is variable to change the wavelength of the output signal.

10. A tunable filter/wavelength converter according to claim 9, wherein the laser source comprises a variable wavelength laser.

11. A tunable filter/wavelength converter according to claim 9, wherein the laser source comprises a plurality of lasers of different wavelength which lasers are individually selectable to provide the further input wavelength.

12. An optical configuration comprising an optical tunable filter/wavelength converter according to any of claims 3 to 11, comprising a demultiplexer having an input for an optical fibre line, several outputs each for a different wavelength signal each of which outputs is coupled via the converter to an optical coupler having an output for connection to an optical fibre line.
